(19) United States
(12) Patent Application Publication
(10) Pub. No.: US 2023/0334467 A1
(43) Pub. Date: Oct. 19, 2023

(54) AUTOFILLING PAYMENT CARD AND CARD VERIFICATION DATA UTILIZING A VIRTUAL CARD EXCHANGE

(71) Applicant: Marqeta, Inc., Oakland, CA (US)

(72) Inventors: Mark Daniel Cline, Alameda, CA (US); Chandrasekaran Subramaniam Iyer Krishnan, Pasadena, CA (US); Rohan Beresford Thompson, Alameda, CA (US)

(21) Appl. No.: 17/659,398

(22) Filed: Apr. 15, 2022

(51) Int. Cl. G06Q 20/34; G06Q 20/22; G06Q 20/40; G06Q 20/06

(52) U.S. Cl. CPC G06Q 20/351; G06Q 20/227; G06Q 20/4018; G06Q 20/065

(57) ABSTRACT

This disclosure describes methods, non-transitory computer readable storage media, and systems that utilize one or more virtual cards to autofill payment information at a user client device for a payment transaction. For example, the disclosed system utilizes a reference identifier to determine a virtual card corresponding to the payment card account based on a virtual card account mapping. The disclosed system provides a stored virtual card identification number and virtual card verification data (e.g., an expiration date and a card verification value) to a user client device for autofilling the virtual card identification number and the virtual card verification data at the user client device in connection with a payment transaction. Additionally, the disclosed system processes the payment transaction in response to receiving a virtual card from a merchant system by swapping the virtual card with the payment card account when providing transaction details to a payment network.

### BACKGROUND

Electronic payment transactions and online banking via client devices (e.g., desktop devices and mobile devices) are increasingly prevalent. For example, many entities (e.g., banks) provide tools that allow customers to engage in payment transactions with other users (e.g., peer-to-peer payment transactions or peer-to-business payment transactions). In particular, entities often provide electronic payment transactions via the use of online tools such as websites or proprietary applications. These websites/applications allow users to initiate electronic payment transactions using information stored on personal devices (e.g., desktops, laptops, mobile devices), such as in a digital wallet or otherwise entered/stored via the personal devices.

While many existing systems provide online and mobile integration of electronic payment systems for users to engage in payment transactions via online or mobile platforms, conventional systems often introduce security concerns in implementing electronic payment transactions. Conventional systems often lack security by exposing payment card credentials (e.g., primary account numbers) and other user information to third parties such as merchant systems, client applications (e.g., browsers), or other systems. By exposing the private information to third parties, these conventional systems can introduce vulnerabilities such as by allowing malicious actors to acquire and use the information for fraudulent purposes.

To overcome some of these security concerns, the conventional systems adopt industry privacy and security standards for electronic payment transactions that require certain information to be transmitted in real-time. To illustrate, payment card industry (“PCI”) standards typically prevent the storage of specific information such as card verification values (e.g., “CVV2” codes) related to payment card accounts. Accordingly, conventional systems require users to manually enter/provide such information each time they authorize payment cards for electronic payment transactions. It is common for users to have difficulty entering payment information, run-out of time, or otherwise become frustrated with the checkout process. Such frustrations often cause potential consumers to abandon their transactions. Frustration with the checkout process is often exacerbated when using a mobile device due to the small screen size and difficulty of typing-in information. Along similar lines, users with older mobile devices or mobile devices with low complexity often do not even attempt to perform transactions on these devices due to the difficulty of entering payment information.

Thus, to comply with such industry standards, the conventional systems often trade usability and ease-of-use for increased security, which interrupts a transaction flow and slows down the transaction process. Accordingly, the conventional systems lack security and efficiency in facilitating electronic payment transactions for users and merchants.

### SUMMARY

This disclosure describes one or more embodiments of methods, non-transitory computer readable media, and systems that solves one or more of the foregoing problems (in addition to providing other benefits). Specifically, in one or more embodiments, the disclosed systems utilize one or more virtual cards to autofill payment information at a user client device for a payment transaction. For example, in response to receiving a request to select a particular payment card account for a payment transaction, the disclosed systems utilize a reference identifier in the request to determine a virtual card corresponding to the payment card account based on a virtual card account mapping. The disclosed systems provide a stored virtual card identification number and virtual card verification data (e.g., an expiration date and a card verification value) to a user client device for autofilling the virtual card identification number and the virtual card verification data at the user client device in connection with a payment transaction. Additionally, the disclosed systems utilize the virtual card account mapping to process the payment transaction in response to receiving a virtual card from a merchant system by swapping the virtual card with the payment card account when providing transaction details to a payment network. By generating one or more virtual cards linked to a payment card account to autofill payment card details, the disclosed systems provide secure and efficient payment transaction processing.

### BRIEF DESCRIPTION OF THE DRAWINGS

The detailed description refers to the drawings briefly described below.

FIG. 1 illustrates a block diagram of a system environment in which a virtual card system is implemented in accordance with one or more implementations.

FIG. 2 illustrates a diagram of an overview of a process for utilizing a virtual card swap to process a payment transaction in accordance with one or more implementations.

FIG. 3 illustrates a sequence-flow diagram of a process for creating an account mapping for a virtual card and a payment card account in accordance with one or more implementations.

FIGS. 4A-4B illustrate a sequence-flow diagram of a process for utilizing a virtual card to autofill payment card verification data in accordance with one or more implementations.

FIGS. 5A-5B illustrate graphical user interfaces for registering a virtual card for a payment card account in accordance with one or more implementations.

FIGS. 6A-6D illustrate graphical user interfaces for utilizing a virtual card of a payment card account to autofill payment card verification data in accordance with one or more implementations.

FIG. 7 illustrates a flowchart of a series of acts for utilizing a virtual card to autofill payment card verification data in a payment transaction in accordance with one or more implementations.

FIG. 8 illustrates a block diagram of an exemplary computing device in accordance with one or more implementations.

### DETAILED DESCRIPTION

This disclosure describes one or more embodiments of a virtual card system that generates virtual cards for autofilling verification data of a payment card and processing payment transactions. In particular, the virtual card system generates one or more limited use virtual cards representing a payment card account in a virtual card account mapping in response to a request to register the payment card account with the virtual card system. In response to a request to select the payment card account for use with a payment transaction, the virtual card system utilizes a reference identifier from the request to obtain a virtual card and verification data (e.g., expiration date and a card verification value) associated with the virtual card. The virtual card system provides the virtual card and verification data to the client device to autofill payment card details in a payment interface for providing to a merchant system. Additionally, in response to receiving a message from the merchant system to process the payment transaction via the virtual card, the virtual card system utilizes the virtual card account mapping to validate the virtual card and swap the virtual card with the payment card account for processing the payment transaction.

As mentioned, in one or more embodiments, the virtual card system receives a request to register a payment card account (e.g., a credit card or debit card) with an autofill service. In response to the request, the virtual card system generates one or more virtual cards to represent the payment card account within a virtual card account mapping. For example, the virtual card system determines a primary account number (“PAN”) associated with the payment card account and maps the PAN to virtual card identification numbers of the one or more virtual cards. Additionally, the virtual card system generates a reference identifier (e.g., a token or other unique identifier) corresponding to the virtual account mapping. In some embodiments, the virtual card system generates a plurality of limited use virtual cards associated with the payment card account for separate purposes (e.g., tied to specific merchant systems).

In one or more embodiments, the virtual card system utilizes a virtual card account mapping to autofill payment card details for a payment transaction. For instance, the virtual card system receives a card selection message including a reference identifier corresponding to a payment card account. The virtual card system utilizes the reference identifier to identify the virtual card account mapping and determine a virtual card corresponding to the payment card account. To illustrate, the virtual card system determines a virtual card identification number and virtual card verification data (e.g., a card verification value, an expiration date) associated with the virtual card.

Additionally, the virtual card system provides the virtual card to the client device in response to the request. Specifically, the virtual card system sends the virtual card, including the virtual card identification number and the virtual card verification data, to the client device. In some embodiments, the virtual card system also provides autofilling instructions to the client device (e.g., via an application programming interface) to cause the client device to autofill payment card details for the payment transaction utilizing the virtual card and corresponding data. Accordingly, the virtual card system causes the client device to autofill payment card details associated with the virtual card in place of payment card details of the payment card account. Furthermore, to initiate the payment transaction, the client device can submit the payment card details associated with the virtual card to a merchant system involved in the payment transaction.

According to one or more embodiments, the virtual card system processes the payment transaction in response to receiving a transaction processing message from the merchant system. For example, the virtual card system determines that the transaction processing message includes information associated with the virtual card provided to the client device. In particular, the virtual card system validates payment card details in the transaction processing message by accessing the virtual card account (e.g., based on a virtual card identification number in the transaction processing message) and comparing the payment card details to data stored in connection with the virtual card account mapping.

In additional embodiments, in response to validating the payment card details in the transaction processing message, the virtual card system communicates with a payment network to process the payment transaction. Specifically, the virtual card system replaces payment card details associated with the virtual card with payment card details associated with the payment card account. To illustrate, the virtual card system can replace the virtual card identification number of the virtual card with the PAN of the payment card account in an authorization message provided to the payment network to process the payment transaction utilizing the payment card account.

The disclosed virtual card system provides a number of benefits over conventional systems. For example, the virtual card system improves the security of computing systems that process electronic payment transactions. In contrast to existing systems that expose payment card credentials (e.g., PANs or user information) to third parties, the virtual card system utilizes virtual cards to provide secure transaction processing by limiting the use of payment card credentials for processing payment transactions. Specifically, the virtual card system improves security of electronic payment transactions by preventing third parties such as browsers/applications and merchants from having access to payment card details by replacing payment card details with virtual card details via a virtual card account mapping. Furthermore, by generating virtual cards for payment card accounts and utilizing the virtual cards to provide payment card details to third parties, the virtual card system can maintain the security of the payment card account even if the virtual card details are accessed or stolen by a malicious actor (e.g., by generating a new virtual card and discarding the compromised virtual card or by minimizing the situations where the stolen details are usable for payment). Thus, by using virtual cards, virtual card system increases security and reduce fraud by allowing a user to purchase items from any number of commerce sites/applications using one or more virtual cards without ever having to provide a payment card number to the commerce sites/applications.

Additionally, the disclosed virtual card system improves the efficiency of computing systems via the use of virtual cards. While existing systems prevent autofilling of certain payment card details such as expiration dates and card verification values due to PCI standards that prevent storage of card verification values—thus requiring users to manually enter such information each time such information is requested—the virtual card system leverages a dynamic virtual card to provide autofilling of payment card details in a transaction. For example, by swapping payment card details of a payment card account for virtual card details of a virtual card, the virtual card system can provide all necessary information for initiating a payment transaction between a user and a merchant system. In particular, the virtual card system can cause a client device to autofill verification data such as an expiration date and a card verification value associated with the virtual card (in addition to other payment data), which provides sufficient information for validating the virtual card for a transaction while complying with PCI standards.

The virtual card system, thus, improves security while also streamlining the transaction process for users. In particular, in one or more embodiments, the virtual card system enables users to efficiently complete a transaction without having to enter most, if not all, payment details necessary to complete a transaction. As such, the virtual card system increases the ease and speed of performing transactions, while also increasing security, particularly on mobile devices with small touch screens that are difficult to use to enter information. On a similar note, the virtual card system enables users to easily and efficiently perform transactions on older or low complexity mobile devices by eliminating the need to enter most, if not all, payment information to complete a transaction.

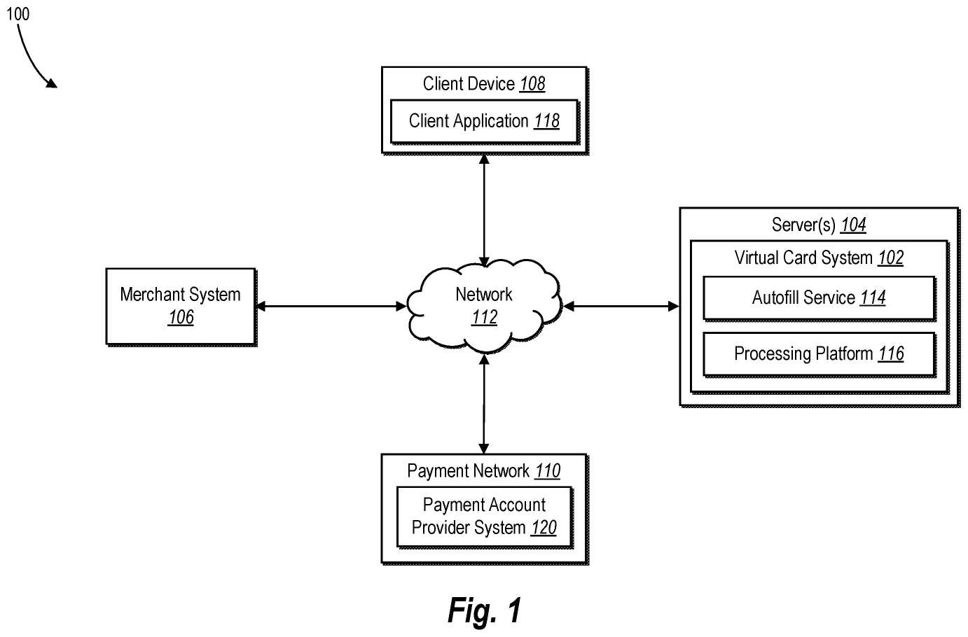

Turning now to the figures, FIG. 1 includes an embodiment of a system environment 100 in which a virtual card system 102 operates. In particular, the system environment 100 includes server(s) 104, a merchant system 106, a client device 108, and a payment network 110 in communication via a network 112. Moreover, as shown, the virtual card system 102 includes an autofill service 114 and a processing platform 116. FIG. 1 also illustrates that the client device 108 includes a client application 118. Furthermore, as shown, the payment network 110 includes a payment card account provider system 120.

As shown, in FIG. 1, the server(s) 104 include or host the virtual card system 102. The server(s) 104 communicate with one or more other components in the system environment 100 to manage one or more virtual cards for a user in connection with a payment card account. As used herein, the term “payment card account” refers to a payment card account including a credit card or a debit card. A payment card account includes a payment card number, an expiration date, and a card verification value.

In one or more embodiments, the virtual card system 102 communicates with the client device 108 to manage a virtual card associated with a payment card account of the user. In particular, a virtual card is linked to an actual payment card account and provides a layer of security. As described below, a virtual card includes details that make the virtual card appear like an actual payment card (e.g., a payment card identification number, an expiration date, and a card verification value) but are different than the corresponding details of the actual payment card account. In one or more embodiments, the virtual card has no algorithmic relationship with an associated actual payment card number, so that the payment card number cannot be derived from the virtual card (such as by merely applying a decryption algorithm to the virtual card). Accordingly, the virtual card is not considered cardholder data, because it is a generated string from which it is not possible to extrapolate any original cardholder data without a mapping between the virtual card and the actual card. By using virtual cards, the virtual card system 102 can process a transaction without having to comply with regulatory standards, e.g., the PCI DSS standards, as explained below.

In one or more embodiments, in connection with managing virtual cards for users, the virtual card system 102 includes the autofill service 114 to perform autofilling of payment card details involving virtual cards for processing payment transactions in connection with the processing platform 116. In particular, the autofill service 114 generates and stores virtual card account mappings between virtual cards and payment card accounts. For instance, the autofill service 114 generates a virtual card account mapping including one or more virtual cards to represent a payment card account. Additionally, the autofill service 114 provides virtual card data for autofilling payment card details at a client device (e.g., the client device 108). Furthermore, the autofill service 114 communicates with the processing platform 116 to process payment transactions based on the virtual card account mappings.

As used herein, the terms “virtual card account mapping” refers to an entry stored in a database or other data storage medium that links one or more virtual cards to a payment credential of a payment card account of a user. To illustrate, a virtual card account mapping creates an association between one or more virtual card identification numbers and a PAN (e.g., a credit/debit card number) of a payment card account. In some embodiments, a virtual card identification number includes a unique number that refers to a specific virtual card (e.g., similar to a credit card number such that it includes 13-19 digits according to industry standards). Furthermore, a virtual card account mapping can include virtual card verification data such as expiration dates and card verification values for virtual cards. In additional embodiments, a virtual card account mapping includes additional parameters associated with processing payment transactions involving one or more virtual cards.

As used herein, the term “payment transaction” refers to an electronic payment transaction in which a payment card account funds a payment to a merchant or merchant system. For instance, a payment transaction includes an electronic payment transaction between a payment card account of a user and a recipient account associated with a merchant system (e.g., the merchant system 106) in a peer-to-business transaction. In one or more embodiments, a payment transaction involves an online purchase via a client application of a client device (e.g., via the client application 118 of the client device 108).

As illustrated in FIG. 1, the client device 108 initiates a payment transaction with the merchant system 106 in connection with a virtual card that is mapped to a payment card account. To illustrate, the client device 108 utilizes the client application 118 (e.g., a browser application, a plugin to a browser application, or integration via other end-user system) to initiate a payment transaction with the merchant system 106. For example, the client device 108 communicates with the autofill service 114 and/or the processing platform 116 of the virtual card system 102 to provide payment card details associated with the virtual card to the merchant system 106 to initiate a payment transaction. In additional embodiments, the virtual card system 102 also allows the creation and management of virtual cards and use of the virtual cards with one or more merchant systems based on the client device 108 communicating with the processing platform 116. Although FIG. 1 illustrates the autofill service 114 and the processing platform 116 being separate, in other embodiments, the autofill service 114 and the processing platform 116 are part of the same component.

The virtual card system 102 (e.g., via the processing platform 116) processes payment transactions by communicating with the payment network 110 to transfer funds from various payment card accounts to merchant accounts. In one or more embodiments, the payment network 110 includes a payment card account provider systems 120 that provides/services one or more payment card accounts for a user. For instance, the payment card account provider system 120 includes one or more payment card networks (e.g., VISA, DISCOVER, or MASTERCARD), issuing or acquiring bank systems, or other systems that provide access to funds via credit card accounts or debit card accounts. To illustrate, a payment card account provider system can provide payment card accounts of one or more payment card account types to one or more users. In addition to the payment card account provider system 120, in some embodiments, the payment network 110 includes gateway payment systems and other devices or systems involved in processing electronic payment transactions. The payment network 110 can also include additional payment account provider networks associated with one or more payment card networks and/or payment account types.

In one or more embodiments, in connection with managing virtual cards for payment card accounts, the virtual card system 102 also provides one or more additional systems or devices with virtual card management tools. For example, the one or more additional systems or devices include the client device 108 and/or the payment card account provider system 120 of the payment network 110. In one or more embodiments, the virtual card system 102 provides one or more application programming interfaces (“APIs”) for the systems or devices to generate one or more virtual cards and generate a virtual card account mapping to a payment card account with a plurality of parameters. To illustrate, payment card account provider system 120 can communicate with the virtual card system 102 via interfacing protocols of the API to provide virtual card management tools at a client device of a user.

In one or more embodiments, the virtual card system 102 securely communicates with the merchant system 106 and the payment network 110 (e.g., the server(s) 104 securely communicates directly or indirectly with the merchant system 106 and the payment network 110) to process electronic payment transactions with virtual cards. In particular, the virtual card system 102 utilizes encryption to verify and authenticate data passed to and from the merchant system 106 (or with a payment facilitator system or other entity assisting with payment transactions such as a browser/application) and/or the payment network 110 in connection with processing electronic payment transactions. More specifically, the virtual card system 102 provides one or more APIs that the merchant system 106 and/or the payment networks 110 leverage to securely communicate with the virtual card system 102 for virtual card management and payment transaction processing.

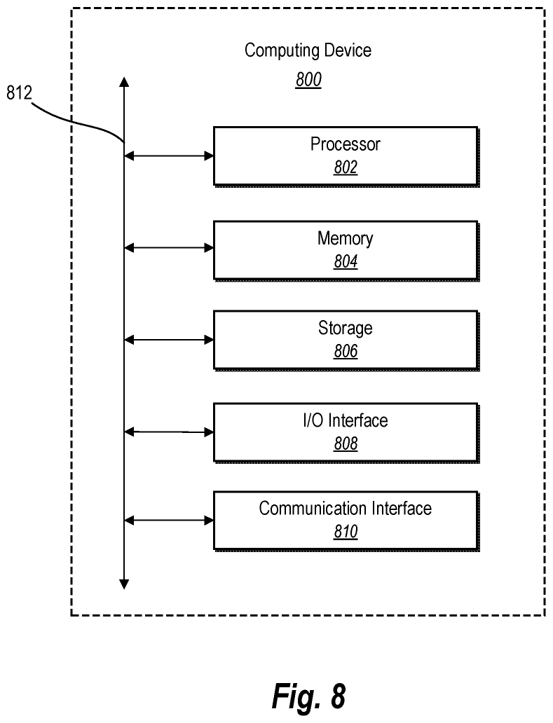

In one or more embodiments, the server(s) 104 include a variety of computing devices, including those described below with reference to FIG. 8. For example, the server(s) 104 includes one or more servers for storing and processing data associated with virtual card management and payment transactions. In some embodiments, the server(s) 104 also include a plurality of computing devices in communication with each other, such as in a distributed storage environment. In some embodiments, the server(s) 104 communicates with a plurality of issuing systems and issuing system devices (e.g., payment card account provider system 120) based on established relationships between the virtual card system 102 and the issuing systems. In additional embodiments, the server(s) 104 communicate with other entities or systems including financial institutions (e.g., issuing banks associated with payment cards), payment card networks associated with processing payment transactions involving payment cards, payment gateways, merchant systems, client devices, or other systems.

In addition, in one or more embodiments, the virtual card system 102 is implemented on one or more servers. For example, while FIG. 1 illustrates a single server (i.e., server(s) 104), the virtual card system 102 can be partially or fully implemented on a plurality of servers. To illustrate, the virtual card system 102 can be implemented in a distributed environment. In one or more embodiments, each server handles requests for utilizing virtual cards to autofill payment card details of payment card accounts of a plurality of users. In additional embodiments, although FIG. 1 illustrates that the virtual card system 102 includes the autofill service 114 and/or the processing platform 116 on the server(s) 104, the autofill service 114 and/or the processing platform 116 may be part of one or more other servers or systems. Additionally, although the above description indicates that the autofill service 114 and the processing platform 116 perform specific operations separately, in other embodiments, the autofill service 114 and/or the processing platform 116 can perform the operations differently. To illustrate, the autofill service 114 can perform operations of the processing platform described above, or vice-versa.

Additionally, as shown in FIG. 1, the system environment 100 includes the network 112. The network 112 enables communication between components of the system environment 100. In one or more embodiments, the network 112 may include the Internet or World Wide Web. Additionally, the network 112 can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server(s) 104, the virtual card system 102, the merchant system 106 and the client device 108 communicate via the network 112 using one or more communication platforms and technologies suitable for transporting data and/or communication signals, including any known communication technologies, devices, media, and protocols supportive of data communications, examples of which are described with reference to FIG. 8. Additionally, in one or more embodiments, one or more of the various components of the system environment 100 communicate using protocols for payment card transactions, financial information communications such as PCI standards, or other protocols.

In addition, as shown in FIG. 1, the system environment 100 includes the client device 108. In one or more embodiments, the client device 108 includes, but is not limited to, a mobile device (e.g., smartphone or tablet), a laptop, a desktop, including those explained below with reference to FIG. 8. Furthermore, although not shown in FIG. 1, the client device 108 can be operated by a user (e.g., a user included in, or associated with, the system environment 100) to perform a variety of functions. In particular, the client device 108 performs functions such as, but not limited to, generating, accessing, viewing, and interacting with a virtual card or a virtual card account. In some embodiments, the client device 108 also performs functions for initiating operations for engaging in payment transactions utilizing a virtual card, managing preferences/parameters associated with the virtual card, or adding or removing a registration of a payment card account with the virtual card. For example, the client device 108 communicates with the server(s) 104 via the network 112 to provide information (e.g., user interactions and/or data) associated with managing a virtual card or for autofilling payment card details based on the virtual card. Although FIG. 1 illustrates the system environment 100 with a single client device, in some embodiments, the system environment 100 includes a different number of client devices.

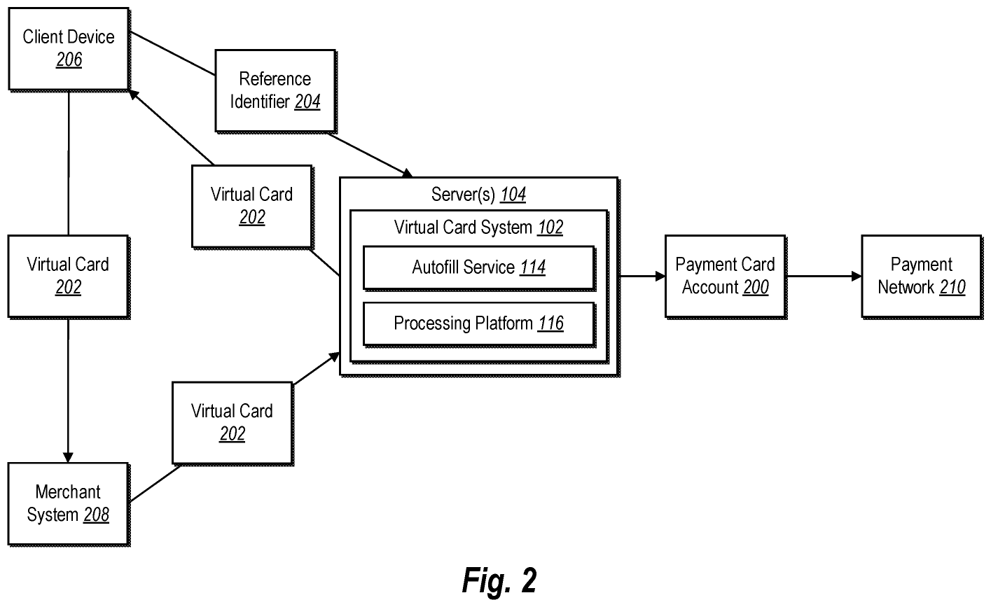

As mentioned, the virtual card system 102 generates a virtual card for autofilling payment card details associated with a payment transaction and for processing the payment transaction. FIG. 2 illustrates a process in which the virtual card system 102 utilizes a virtual card to process a payment transaction between a user and a merchant. Specifically, FIG. 2 illustrates that the virtual card system 102 substitutes a virtual card in place of a payment card for autofilling payment card details and initiating the payment transaction between the user and the merchant.

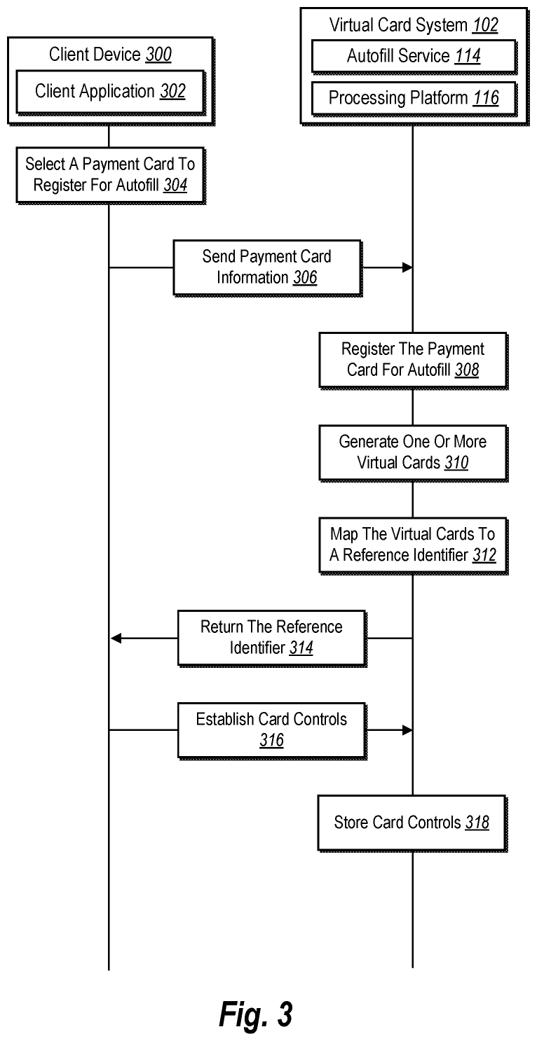

In one or more embodiments, the virtual card system 102 generates a virtual card account mapping between a payment card account 200 and a virtual card 202. For instance, the virtual card system 102 generates the virtual card 202 in response to a request to register the payment card account 200 with an autofill service 114 of the virtual card system 102, as further described in more detail with respect to FIG. 3. The virtual card system 102 (e.g., via the processing platform 116) generates the virtual card 202 in response to the request and associates the virtual card 202 with the payment card account 200 in connection with a reference identifier 204. In one or more embodiments, the reference identifier 204 includes a set of numerals and/or letters, a token, or other identifier mapped to a PAN of the payment card account 200.

As illustrated in FIG. 2, as part of a payment transaction involving the payment card account 200, a client device 206 sends the reference identifier 204 to the virtual card system 102. To illustrate, the client device 206 provides the reference identifier 204 to the autofill service 114 of the virtual card system 102 to obtain the virtual card 202 mapped to the payment card account 200. In addition, the virtual card system 102 returns the virtual card 202 to the client device 206 based on the reference identifier 204 corresponding to the virtual card account mapping. For example, the autofill service 114 (e.g., in connection with the processing platform 116) provides the virtual card 202 with additional virtual card verification data to the client device 206 to autofill payment card details within a purchase interface according to the virtual card 202.

In one or more embodiments, as illustrated in FIG. 2, the client device 206 provides the virtual card 202 to a merchant system 208 as part of the payment transaction. In particular, the client device 206 provides the virtual card 202 (and corresponding virtual card details) to the merchant system 208 in place of the payment card account 200. Accordingly, the client device 206 provides the virtual card 202 in response to the autofill service 114 causing the client device 206 to autofill payment card details associated with the virtual card 202 in connection with the payment transaction. Furthermore, as illustrated in FIG. 2, the merchant system 208 provides the virtual card 202 to the virtual card system 102 to process the payment transaction.

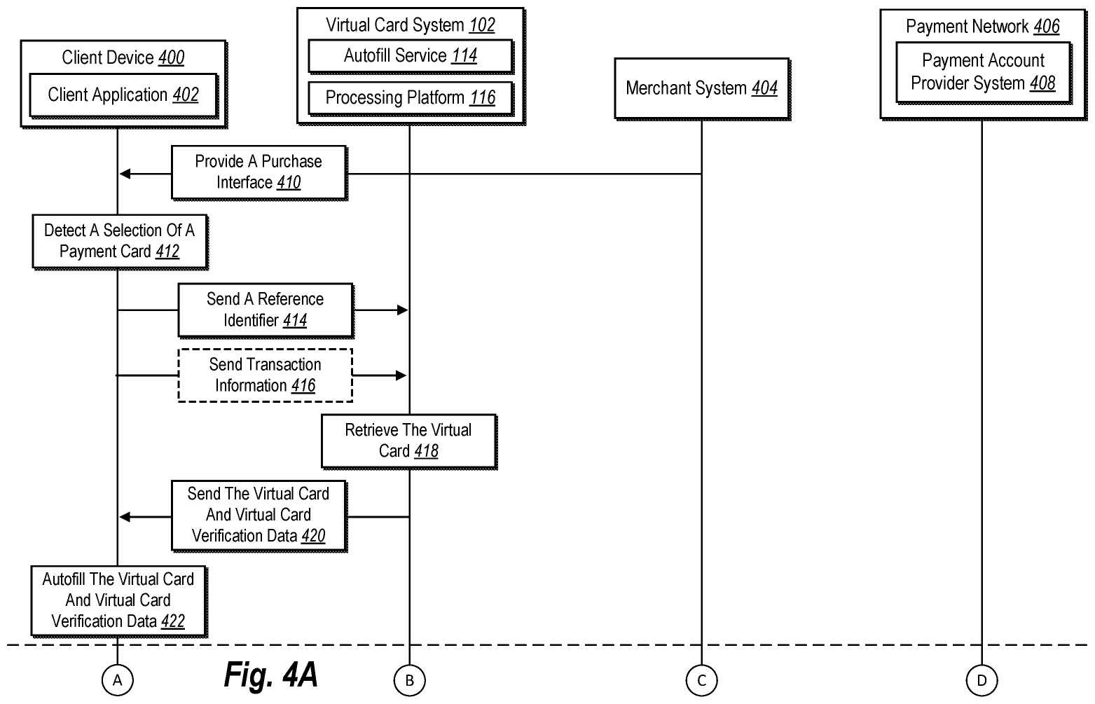

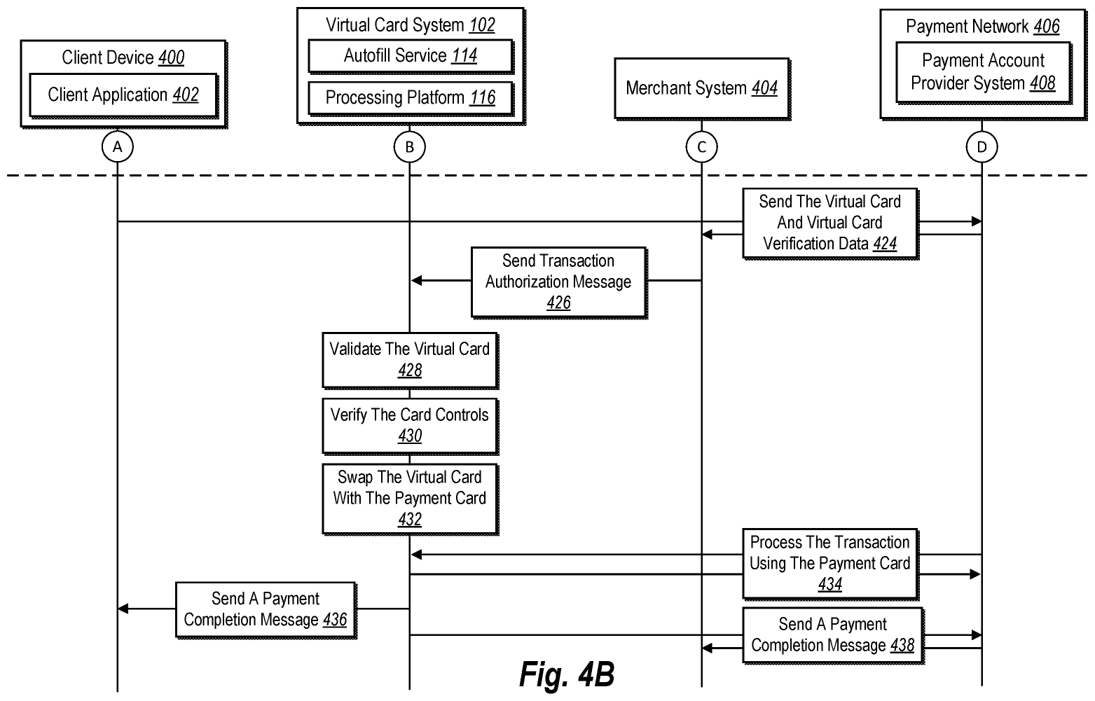

According to additional embodiments, the virtual card system 102 validates the virtual card 202 based on the virtual account mapping. Specifically, the virtual card system 102 (e.g., the autofill service 114) utilizes the virtual card 202 and the corresponding virtual card verification data to validate the virtual card 202 received from the merchant system 208. In response to validating the virtual card, and as illustrated in FIG. 2, the virtual card system 102 swaps the virtual card 202 with the payment card account 200. Additionally, the virtual card system 102 (e.g., the processing platform 116) sends the payment card account 200 to a payment network 210 to process the payment transaction utilizing the payment card account 200. Accordingly, the payment network 210 processes the payment transaction to transfer funds from the payment card account to a merchant account associated with the merchant system 208. FIGS. 4A-4B and the corresponding description provide additional detail regarding the use of a virtual card in connection with a payment transaction.

As mentioned, FIG. 3 illustrates an example of a process in which the virtual card system 102 associates a payment card account with a virtual card for facilitating payment transactions between a user and one or more merchants. In particular, as illustrated in FIG. 3, a client device 300 includes a client application 302 and the virtual card system 102 for generating virtual cards and parameters associated with utilizing the virtual cards in connection with payment transactions. The client application 302 includes, for example, a web browser, a merchant application, or payment card application that provides tools for a user to manage a payment card account. In some embodiments, the client device provides tools (e.g., via the client application 302) for generating and utilizing a virtual card during a payment transaction. In alternative embodiments, the client device 300 provides tools for generating and utilizing a virtual card prior to, or otherwise separately from, initiating a payment transaction.

As illustrated in FIG. 3, in one or more embodiments, the client device 300 performs an act 304 of selecting a payment card to register for autofill. For example, as mentioned, the client device 300 can display an option to register the payment card for autofilling payment card details for a payment transaction involving the client device 300. To illustrate, the client device 300 displays an option to enter payment credentials for a new payment card. In other embodiments, the client device 300 displays an option to select one of a plurality of previously entered/stored payment credentials for one or more payment cards. Additionally, the client device 300 can provide a request for the user to verify that the user agrees to utilize autofilling for the payment card.

In some embodiments, the client device 300 displays an option to associate the payment card (e.g., a corresponding payment card account of the payment card) with a virtual card within a purchase interface associated with a purchase of goods or services from a merchant system. For example, the client device 300 can display the option to select the payment card within the process flow of a payment transaction (e.g., during checkout). In alternative embodiments, the client device 300 displays the option to associate the payment card with a virtual card independently of a given payment transaction. For instance, the client device 300 can display the option within a card management interface of the client application 302.

In one or more embodiments, in response to a selection of a payment card at the client device 300, FIG. 3 illustrates that the client device 300 performs an act 306 of sending payment card information for the payment card to the virtual card system 102. Specifically, the client device 300 determines a payment card identifier (e.g., a PAN) associated with a payment card account based on the selected payment card. In some instances, the client device 300 also determines additional information associated with the payment card such as, but not limited to, payment card verification data including an expiration date, a card verification value, an address, a phone number, or an account owner associated with the payment card.

As used herein, the term “card verification value” refers to a series of numbers that acts as a security feature for payment transactions. In one or more embodiments, a card verification value (typically referred to as “CVV” or “CVV2”) includes three digits or four digits that provide security for a payment card in addition to a PAN (or other payment card number), especially for transactions in which a payment card is not present at a site of the payment transaction (e.g., not at a physical location of a point-of-sale terminal). Thus, payment transactions involving online purchases may require a card verification value and/or other information associated with a payment card account to validate the payment card account.

According to one or more embodiments, the client device 300 sends the payment card information to the virtual card system 102 via an API provided by the virtual card system 102. For example, the virtual card system 102 can create and manage an API that exposes a plurality of interaction operations to devices or systems such as the client device 300 (e.g., via the client application 302) or a payment account provider system. The client device 300 can integrate with the virtual card system 102 via the API to allow the virtual card system 102 to access data associated with payment card accounts, validate payment card accounts, and perform other operations associated with payment card accounts. In one or more embodiments, the client device 300 integrates with the virtual card system 102 via the API (e.g., in an API call via the client application 302) in response to, or otherwise in connection with, a request to register a payment card account with the autofill service 114. The client device 300 can thus send the payment card information to the autofill service 114 via a secure communication according to the API protocols established by the virtual card system 102.

As illustrated in FIG. 3, in one or more embodiments, the virtual card system 102 (e.g., utilizing the autofill service 114) performs an act 308 of registering the selected payment card for autofill in connection with payment transactions. Specifically, the virtual card system 102 can generate one or more virtual card account mappings in response to the selected payment card being selected for registration. For instance, the virtual card system 102 can store a PAN of the payment card account along with some of the additional payment card information received from the client device 300 in a virtual card account mapping of an autofill database. In some embodiments, the virtual card system 102 stores information for the payment card in compliance with PCI standards and security requirements. Accordingly, in such cases, the virtual card system 102 may not store a card verification value (or other industry-prohibited data) of the payment card information in the virtual card account mapping.

In one or more embodiments, as part of registering the payment card for autofill, the virtual card system 102 validates the payment card information. In particular, the virtual card system 102 (e.g., via the processing platform 116) can provide some, or all, of the payment card information to a payment account provider system of a payment network. The payment account provider system can verify that the payment card information is accurate based on stored data for the payment card. More specifically, because the payment account provider system created the payment card account, the payment account provider system can verify that the information received from the virtual card system 102 matches the generated information. The payment account provider system can notify the virtual card system 102 that the payment card information is valid. The virtual card system 102 can register the payment card for autofill in response to receiving the notification that the payment card information is valid.

In addition, as illustrated in FIG. 3, the virtual card system 102 performs an act 310 of generating one or more virtual cards in connection with registering the payment card for autofill. In one or more embodiments, the virtual card system 102 generates a plurality of virtual cards to represent the payment card for a plurality of different purposes. For instance, the virtual card system 102 can generate a first virtual card for a first limited use, a second virtual card for a second limited use, etc. Furthermore, in one or more embodiments, the first virtual card corresponds to uses of the payment card in payment transactions involving a first merchant system, the second virtual card corresponds to uses of the payment card in payment transactions involving a second merchant system, etc. In other embodiments, the virtual cards correspond to other limited uses such as transaction types, transaction times, geographical locations of merchant systems, recipient categories, or others. The virtual card system 102 can generate the plurality of virtual cards based on past user behavior or other details associated with payment transactions corresponding to the user.

In connection with generating the virtual cards to represent the payment card, the virtual card system 102 also generates virtual card information corresponding to the virtual cards. For example, the virtual card system 102 generates a unique virtual card identification number for each virtual card. Additionally, the virtual card system 102 can generate virtual card verification data for each virtual card including, but not limited to, an expiration date and a card verification value. The virtual card verification data thus provides additional security measures for validating the virtual cards in connection with payment transactions. The virtual card system 102 can store the virtual card identification numbers and virtual card verification data with the payment card in the virtual card account mapping.

In one or more embodiments, as illustrated in FIG. 3, the virtual card system 102 performs an act 312 of mapping the virtual cards to a reference identifier. In particular, the virtual card system 102 generates a unique reference identifier for use in verifying communications involving one or more client devices associated with the payment card. To illustrate, the virtual card system 102 generates a token (e.g., a combination of numbers and/or letters) representing the payment card or the virtual card account mapping. In additional embodiments, the virtual card system 102 generates a unique reference number corresponding to the payment card or the virtual card account mapping. The virtual card system 102 stores the reference identifier with the virtual card account mapping.

According to one or more embodiments, as illustrated in FIG. 3, the virtual card system 102 preforms an act 314 of returning the reference identifier to the client device 300. The virtual card system 102 sends the reference identifier to the client device 300 in response to the client device sending the request to register the payment card for autofill. To illustrate, the virtual card system 102 utilizes an API integration of the client device 300 (e.g., via the client application 302) to send the reference identifier to the client device. In some embodiments, the client device 300 stores the reference identifier in memory in connection with the client application 302 (e.g., in a browser cache or with a user account associated with the client application 302) and displays an indicator of the virtual card account mapping (e.g., with a graphical depiction of a virtual card). By storing the reference identifier at the client device 300, the virtual card system 102 allows the client device 300 to make calls to the virtual card system 102 to autofill payment card details in connection with payment transactions involving the payment card.

According to one or more embodiments, the virtual card system 102 also provides tools for setting additional parameters for virtual cards associated with a payment card. As illustrated in FIG. 3, the client device 300 performs an act 316 of establishing card controls for the virtual cards associated with the payment card by communicating with the virtual card system 102 (e.g., via the client application 302 or another client application utilizing API integration with the virtual card system 102). To illustrate, the client device 300 displays one or more options for determining one or more uses of the payment card in connection with payment transactions. Specifically, the client device 300 can display options for setting spending limits, transaction types, merchants, merchant categories, geographic boundaries, transaction times, or other limits on the use of the payment card for payment transactions. In response to input selecting or defining one or more card controls for the payment card, the client device 300 can send the card controls virtual card system 102.

Additionally, as illustrated in FIG. 3, the virtual card system 102 performs an act 318 of storing the card controls with the virtual card account mapping. In particular, the virtual card system 102 stores the card controls in the virtual card account mapping and associates the card controls to one or more of the virtual cards in the virtual card account mapping. In some embodiments, the virtual card system 102 stores a first set of controls for a first virtual card, a second set of controls for a second virtual card, etc. Alternatively, the virtual card system 102 applies all of the card controls to each of the virtual cards mapped to the payment card.

In additional embodiments, rather than generating the virtual cards prior to storing the card controls, the virtual card system 102 utilizes the card controls to determine how many virtual cards to generate for the payment card. To illustrate, the virtual card system 102 can determine that a card control limits use of the payment card to a set of defined (e.g., allowed) merchants. The virtual card system 102 can generate a virtual card for each of the defined merchants. Thus, the virtual card system 102 can limit the number of virtual cards associated with the payment card by generating the virtual cards after first determining the usage limits of the payment card.

Once the virtual card system 102 has set up a virtual card for a payment card account, the virtual card is usable in connection with payment transactions. FIGS. 4A-4B illustrate an example process for utilizing a virtual card to autofill payment card information for a payment transaction. Specifically, FIGS. 4A-4B illustrate a client device 400 including a client application 402 engaging in a payment transaction with a merchant system 404. Additionally, as illustrated, the virtual card system 102 communicates with a payment network 406 including a payment account provider system 408 to process the payment transaction.

According to one or more embodiments, the client device 400 engages in a payment transaction with the merchant system 404 in connection with a purchase of a good or service offered by the merchant system 404. For example, as illustrated in FIG. 4A, the merchant system 404 performs an act 410 of providing a purchase interface to the client device 400 for a user to purchase the good or service. Specifically, the merchant system 404 communicates with the client device 400 to provide the purchase interface for display at the client device 400 via the client application 402. Accordingly, the client device 400 displays the purchase interface within the client application 402, which may include a web browser or a proprietary application displaying the purchase interface in a website of the merchant system 404, a separate screen, in a pop-up window, etc.

As illustrated in FIG. 4A, in connection with the merchant system 404 providing the purchase interface for display at the client device 400, the client device performs an act 412 of detecting a selection of a payment card via the purchase interface. In particular, the client device 400 provides an option to select a payment card account that the virtual card system 102 previously stored. To illustrate, the client device 400 or another system associated with the client device 400 (e.g., via the client application 402 or another client application) stores information for previously provided payment card accounts. In some instances, the client device 400 stores an obfuscated version (e.g., a token) representing the payment card account for displaying a name or other identifier of the payment card account so that a user can easily identify the payment card account without storing or presenting sensitive information. In additional embodiments, the virtual card system 102 also provides an option to add one or more new payment card accounts for use with an autofill service.

In one or more embodiments, as illustrated in FIG. 4A, the client device 400 performs an act 414 of sending a reference identifier to the virtual card system 102. Specifically, the client device 400 determines the reference identifier based on the selected payment card. For instance, the client device 400 accesses the reference identifier by utilizing stored information for the selected payment card in a mapping or cache on the client device 400, or with a digital wallet service at the client device 400 or on another device or system. The stored information can include, but is not limited to, user information, account information associated with the payment card, and the reference identifier.

Additionally, the client device 400 sends the reference identifier to the virtual card system 102 (e.g., to the autofill service 114) by leveraging an API provided by the virtual card system 102. To illustrate, the client device 400 can execute the client application 402 to make an API call to the autofill service 114 to retrieve a virtual card corresponding to the payment card by utilizing the reference identifier. The client device 400 may thus interface with the virtual card system 102 utilizing the API call to perform operations in connection with autofilling payment card details within the purchase interface including requesting to retrieve a virtual card utilizing the reference identifier.

In one or more additional embodiments, as illustrated in FIG. 4A, the client device optionally performs an act 416 of sending transaction information to the virtual card system 102. For example, the client device 400 determines a merchant identifier associated with the merchant system 404 in connection with the payment transaction. The merchant identifier can include a merchant name or a unique identifier that allows the virtual card system 102 to identify the merchant system 404. In some embodiments, the transaction information also includes a payment amount, geographical information associated with the client device 400 (e.g., GPS location) or the merchant system 404, a transaction time/date, a transaction type, or other information that the virtual card system 102 can utilize to validate the payment card for use with the transaction.

As illustrated in FIG. 4A, according to some embodiments, the virtual card system 102 performs an act 418 of retrieving the virtual card based on the reference identifier. Specifically, the virtual card system 102 can utilize the reference identifier to access a virtual card account mapping that includes the reference identifier. For example, the virtual card system 102 searches an account mapping database to find the virtual card account mapping utilizing the reference identifier in the query. The virtual card system 102 can thus determine that the reference identifier corresponds to the payment card, which is further linked to one or more virtual cards via the virtual card account mapping.

In connection with accessing the virtual card account mapping corresponding to the reference identifier, the virtual card system 102 selects a virtual card from the virtual card account mapping. In particular, in response to determining that the virtual card account mapping includes a plurality of virtual cards corresponding to the payment card, the virtual card system 102 utilizes transaction information to select a specific virtual card. For instance, the virtual card system 102 utilizes a merchant identifier from the transaction information received from the client device 400 to select, from the plurality of virtual cards, a virtual card limited to use with a specific merchant system. In alternative embodiments, the virtual card system 102 utilizes other transaction information such as a transaction date/time or transaction type to select a particular virtual card from the virtual card account mapping.

In additional embodiments, the virtual card system 102 randomly selects a virtual card from the plurality of virtual cards to utilize in connection with the payment transaction. For example, the virtual card system 102 can generate a predetermined number of virtual cards for a payment card. Alternatively, the virtual card system 102 can generate virtual cards on-demand (e.g., based on transactions involving different merchant systems or other transaction scenarios). The virtual card system 102 can also register the randomly selected virtual card to the merchant system (or transaction type, etc.) associated with the transaction. The virtual card system 102 can utilize the registration of the virtual card to the merchant system so that subsequent transactions involving the merchant system utilize the same virtual card. Additionally, in response to the virtual card being compromised, the virtual card system 102 can replace the virtual card with a new virtual card and register the new virtual card with the merchant system, a payment facilitator system, a digital wallet, or other card system.

In one or more embodiments, the virtual card system 102 utilizes a model that leverages a database of merchant information to more accurately identify the merchant and/or transaction information. For example, the virtual card system 102 can obtain a URL and/or keywords associated with the payment transaction from the client application 402 (e.g., from a browser). The virtual card system 102 can then perform a search in the database to determine a merchant system corresponding to the URL/keywords. The virtual card system 102 can also obtain a merchant identifier from the database to identify the merchant system 404 and select a virtual card.

In one or more embodiments, as illustrated in FIG. 4A, the virtual card system 102 performs an act 420 of sending the virtual card and virtual card verification data to the client device 400. Specifically, the virtual card system 102 generates one or more virtual cards with virtual card verification data that allows the virtual card system 102 to validate the virtual card(s). To illustrate, in response to a request to retrieve a virtual card, the virtual card system 102 can generate a card verification value (e.g., in real-time) or otherwise access the card verification value for the virtual card. Accordingly, each virtual card generated by the virtual card system 102 has an expiration date (e.g., generated previously or in real-time) and card verification value that, when provided in combination with a virtual card identification number corresponding to the virtual card, allow the virtual card system 102 to validate the virtual cards in connection with payment transactions. Because the virtual card system 102 provides the card verification value in real-time, the virtual card system 102 can utilize the card verification value to validate the virtual card for the transaction while complying with PCI standards (e.g., by not storing the card verification value).

In one or more embodiments, the virtual card system 102 also utilizes controls to manage the use of the virtual card in payment transactions. For example, the virtual card system 102 can establish merchant controls that prevent tokenization of the virtual card identification number (or virtual card verification data) of the virtual card. To illustrate, the virtual card system 102 blocks tokenization attempts from the merchant system 404 (e.g., by blocking certain types of payment models or requests to add the virtual card to a digital wallet).

As illustrated in FIG. 4A, in response to receiving the virtual card and the virtual card verification data from the virtual card system 102, the client device 400 performs an act 422 of autofilling the virtual card and the virtual card verification data in connection with the payment transaction. In particular, the client device 400 identifies one or more input fields for entering virtual card verification data within the purchase interface. The client device 400 then automatically inserts the virtual card identification number and the virtual card verification data into the corresponding fields. To illustrate, the client device 400 inserts an expiration date of the virtual card verification data into an expiration date field and a card verification value into a CVV field within the purchase interface.

As previously mentioned, the virtual card system 102 can retrieve the virtual card to provide to the client device 400 in response to an API call. The virtual card system 102 can also provide autofilling instructions to the client device 400 (e.g., for executing via the client application 402) to autofill information associated with the virtual card into the purchase interface based on the API call. Accordingly, the virtual card system 102 can cause the client device 400 to automatically insert required information for the virtual card to initiate the payment transaction into the purchase interface based on the previous selection of a corresponding payment card.

Once the client device 400 has received and autofilled the virtual card information for the payment transaction, FIG. 4B illustrates that the client device 400 performs the act 424 of sending the virtual card and the virtual card verification data to the merchant system 404 via the payment network 406. Specifically, the client device 400 (via the purchase interface in the client application 402) sends the virtual card and virtual card verification data to the payment network 406 instead of the payment card and corresponding verification data. The payment network 406 sends the received virtual card and virtual card verification data to the merchant system 404. For example, the client device 400 sends the virtual card and virtual card verification data to the merchant system 404 (by way of the payment network 406) via a request to initiate an electronic payment transaction to transfer funds to an account of the merchant system 404.

As illustrated in FIG. 4B, the merchant system 404 performs an act 426 of sending a transaction authorization message to the virtual card system 102 in connection with the payment transaction. For example, the merchant system 404 can verify that a virtual card identification number of the virtual card corresponds to the virtual card system 102 (e.g., based on a particular set of digits in the virtual card identification number). The merchant system 404 can generate the transaction authorization message to include the virtual card including the virtual card identification number and the virtual card verification data received from the client device 400. More specifically, the merchant system 404 utilizes an API call to pass the transaction authorization message to the processing platform 116 of the virtual card system 102.

In one or more embodiments, in response to receiving the transaction authorization message from the merchant system 404, FIG. 4B illustrates that the virtual card system 102 performs an act 428 of validating the virtual card. For example, the processing platform 116 utilizes the received virtual card to verify details stored at the virtual card system 102. To illustrate, the processing platform 116 compares the virtual card identification number and the virtual card verification data against a stored virtual card identification number and stored virtual card verification data for the virtual card. Thus, the virtual card system 102 can verify that the virtual card identification number, expiration date, and card verification value correspond to the virtual card based on the virtual card account mapping. In some embodiments, the virtual card system 102 also validates other information associated with the virtual card based on information corresponding to the payment card in the virtual card account mapping including, but not limited to, a user identifier (e.g., a name), an address, or a phone number.

In additional embodiments, the virtual card system 102 also performs an act 430 of verifying the card controls, as illustrated in FIG. 4B. To illustrate, the virtual card system 102 determines one or more details of the payment transaction including, but not limited to, a payment amount, a merchant identifier, a transaction type, a transaction date/time, or a geographical location of the merchant. The virtual card system 102 can access a set of card controls corresponding to the payment card and/or the virtual card based on the virtual card account mapping. In response to determining that the payment transaction information meets thresholds or transaction requirements indicated by the card controls, the virtual card system 102 can proceed with processing the transaction. In response to determining that one or more of the details of the payment transaction does not meet thresholds or requirements indicated by the card controls, the virtual card system 102 can reject the payment transaction.

As illustrated in FIG. 4B, according to one or more embodiments, the virtual card system 102 performs an act 432 of swapping the virtual card with the payment card. Specifically, in response to validating the virtual card from the transaction authorization message, the virtual card system 102 replaces the virtual card with the payment card. To illustrate, the virtual card system 102 can replace the virtual card identification number with the PAN of the payment card. Additionally, the virtual card system 102 can access other information stored for the payment card (e.g., a device identifier, a user identifier) to process the payment transaction.

In one or more embodiments, the virtual card system 102 performs an act 434 of processing the transaction using the payment card, as illustrated in FIG. 4B. In particular, the virtual card system 102 sends the PAN of the payment card (or a token representing the PAN) to the payment network 406. For example, the virtual card system 102 sends the PAN to the payment account provider system 408 along with transaction details such as the payment amount and the merchant identifier.

The payment account provider system 408 can validate the payment card based on the PAN (and any additional information provided with the PAN). The payment account provider system 408 can also process the transaction by transferring funds from the payment card account of the payment card to an account of the merchant system 404. The payment network 406 can notify the virtual card system 102 in response to successfully processing the payment transaction to transfer funds from the payment card account to the account of the merchant system 404.

As illustrated in FIG. 4B, after successfully processing the payment transaction via the payment network 406, the virtual card system 102 performs an act 436 to send a payment completion message to the client device 400. The payment completion message can cause the client device 400 to display an indicator of the successfully completed transaction in addition to one or more details of the payment transaction. Furthermore, as illustrated in FIG. 4B, the virtual card system 102 can perform an act 438 of sending a payment completion message to the merchant system 404 via the payment network 406. More specifically, the virtual card system 102 can send the payment completion message 438 to the payment network 406, which forwards the payment completion message 438 to the merchant system 404. The payment completion message to the merchant system 404 can include the payment transaction details including an identifier of the user and/or the payment card along with information about a purchase of a good or service.

In one or more additional embodiments, the virtual card system 102 also provides virtual cards for use in processing recurring payment transactions. For example, the virtual card system 102 can utilize an autofill service to provide the virtual card to a client device in an initial payment transaction for a recurring charge. The client device can autofill the virtual card details and provide the virtual card to the recipient system. The recipient system can utilize the virtual card to process the initial payment transaction via the virtual card system 102. In some embodiments, the virtual card system 102 can authorize recurring transactions based on the virtual in response to an indication of the recurring transactions provided with the initial transaction to the virtual card system 102. The virtual card system 102 can register the virtual card to the merchant system so that subsequent transactions are not required to be initiated via a browser or client application of the client device.

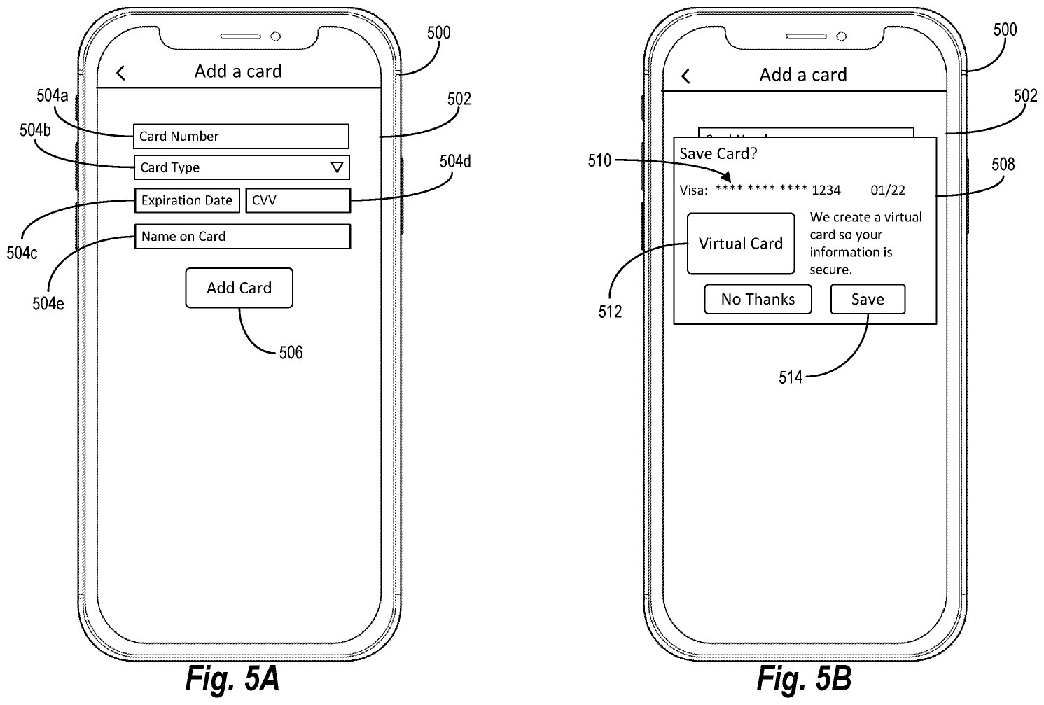

As mentioned, the virtual card system 102 provides tools for creating and configuring a virtual card for use in an autofilling service for payment transactions. Specifically, the virtual card system 102 provides tools for linking a payment card account to one or more virtual cards and setting card controls for use of the payment card/virtual cards. FIGS. 5A-5B illustrate a plurality of graphical user interfaces generated by the virtual card system 102 and provided to a client device 500 including a client application 502 for registering a payment card with an autofill service and generating virtual cards for the payment card.

FIG. 5A illustrates the client device 500 (e.g., a mobile device) displaying a graphical user interface 502 of the client application in connection with registering a payment card for an autofill service. In particular, the virtual card system 102 generates and provides a graphical user interface to the client device 500 that includes an option for a user to add a payment card to a digital wallet or other electronic payment application. In some instances, the client device 500 displays the graphical user interface 502 in response to a request to add the payment card during a process to initiate a payment transaction. In alternative embodiments, the client device 500 displays the graphical user interface 502 in connection with managing a user account associated with a digital wallet or other electronic payment application.

The graphical user interface 502 includes one or more options for entering information associated with a payment card. To illustrate in FIG. 5B, the graphical user interface 502 includes a plurality of input fields 504a-504e to input various payment credentials or other details associated with the payment card. For example, graphical user interface 502 includes a first input field 504a for entering a card number (e.g., a PAN) of the payment card, a second input field 504b for selecting a card type (an issuer of the payment card), a third input field 504c for entering an expiration date of the payment card, a fourth input field 504d for entering a card verification value of the payment card, and a fifth input field 504e for entering a name associated with the payment card. The graphical user interface 502 also includes an add card option 506 to add the payment card based on the provided information.

In response to a selection to add a payment card, the virtual card system 102 can provide a request for the user to register the card with an autofill service (e.g., to generate a virtual card for the payment card). FIG. 5B illustrates that the virtual card system 102 can generate and the client device 500 can display an overlay 508 including a summary of the payment card with a request to save the card as a virtual card. For instance, the summary of the payment card can include payment card details 510 such as an obfuscated PAN (e.g., showing only the last four digits) and an expiration date of the payment card.

Additionally, as shown, the overlay 508 can include a visual representation 512 of a virtual card. Specifically, the overlay 508 can include the request to save the payment card as a virtual card with a note indicating that the payment card information will be stored and used securely via the use of the virtual card. Accordingly, the virtual card system 102 also provides a save option 514 to save the payment card as a virtual card by generating an autofill registration message to send to the virtual card system 102 with payment card details. In addition to securely storing and using the payment card via the virtual card, saving the payment card can also register the payment card for an autofill service.

In some embodiments, the virtual card system 102 also provides options for setting payment card controls for the payment card and corresponding virtual card to customize when and how a virtual card can be involved in payment transactions. For instance, the virtual card system 102 generates a graphical user interface 502 that includes options for selecting a variety of additional restrictions or parameters that determine how to process payment transactions for the virtual card. In one or more embodiments, the additional parameters include, but are not limited to, locations, transaction types, dates, times, total payment amounts, account balances, or other characteristics that the virtual card system 102 can use in validating the virtual card for a payment transaction.

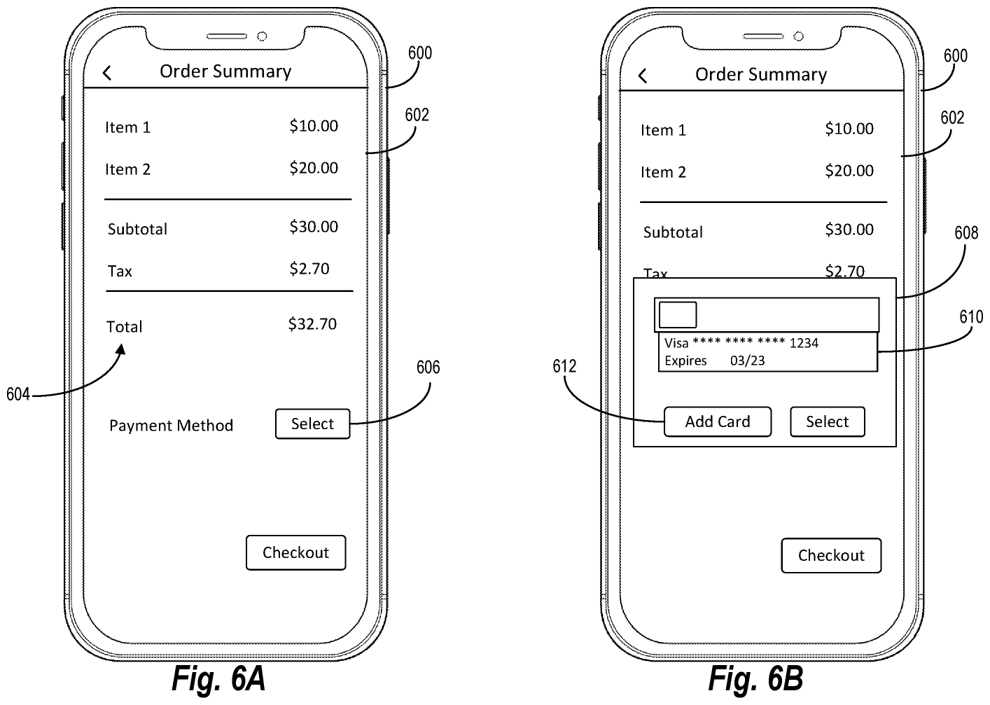

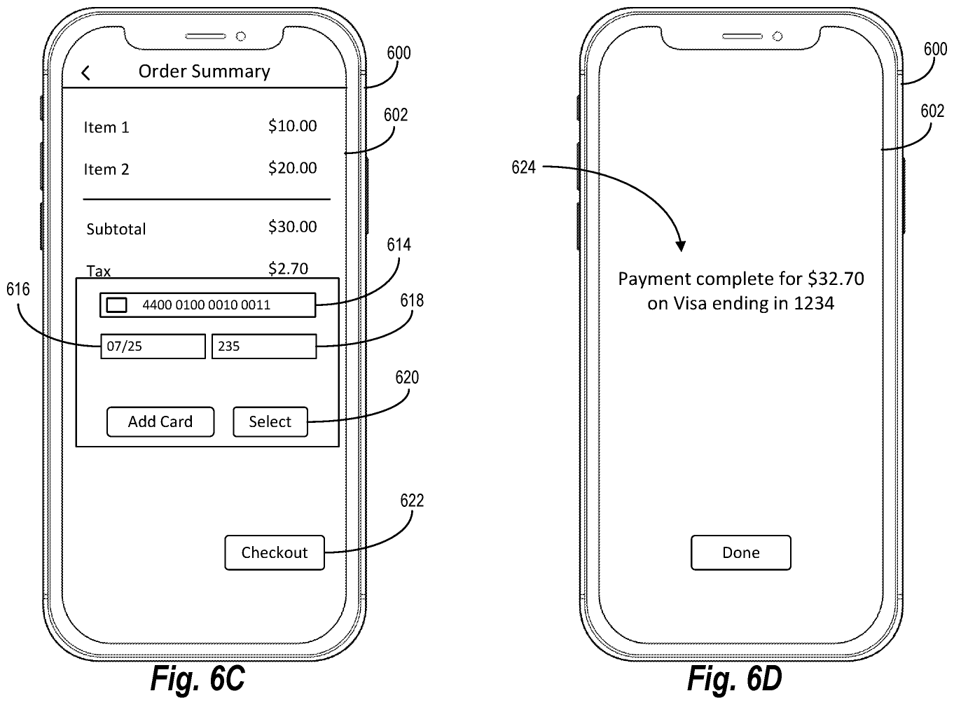

Once the virtual card system 102 has created a virtual card for a payment card and registered the payment card for an autofill service in an account mapping, the virtual card system 102 utilizes the account mapping to process payment transactions involving the payment card. FIGS. 6A-6D illustrate an example of graphical user interfaces for processing a payment transaction utilizing a virtual card in connection with a selected payment card. Specifically, FIGS. 6A-6D illustrate a client device 600 including a client application that displays the graphical user interface 602 for initiating a payment transaction utilizing a payment card by swapping the payment card information for virtual card information.

FIG. 6A illustrates that the client device 600 displays a graphical user interface 602 including an order summary in connection with a purchase of a good or service by a consumer from a merchant system. For example, the client device 600 can display the graphical user interface 602 with a summary 604 of products and costs associated with the purchase. In particular, the client device 600 displays a subtotal of costs associated with selected products, tax associated with the purchase, and a total amount based on the subtotal and tax. In various embodiments, the order summary corresponds to an online order via a website or a proprietary client application associated with the merchant system.

Furthermore, the graphical user interface 602 includes a payment method option 606 that allows a user to select a payment method for initiating a payment transaction for the purchase. In one or more embodiments, the client device 600 determines whether a user account associated with a user of the client device 600 includes one or more existing payment accounts (e.g., via a digital wallet stored on the client device 600). Additionally, in some embodiments, the client device 600 detects a selection of the payment method option 606 to select from the existing accounts or to enter a new account for use in initiating a payment transaction to complete the purchase.

As illustrated in FIG. 6B, in response to a selection of the payment method option 606, the client device 600 displays an overlay 608 for selecting a payment method. To illustrate, the overlay 608 can include an input field to select from a plurality of previously stored payment cards from a digital wallet associated with the user. In particular, in response to a user input selecting the input field, the client device 600 displays a dropdown list 610 with one or more payment cards previously stored. As shown, the dropdown list 610 includes a payment card (e.g., a credit card or debit card) that the user previously entered for storing in a digital wallet. Additionally, the dropdown list 610 can include an obfuscated payment card number (e.g., an obfuscated PAN) and an expiration date stored for the payment card. Furthermore, as previously noted, the digital wallet does not include a card verification value for the payment card due to PCI standards.

In one or more embodiments, the overlay 608 includes an add card option 612 to add a new payment card for use as the payment method for the purchase. Specifically, in response to a selection of the add card option 612, the client device 600 can display an additional interface or overlay for adding payment card details associated with a new payment card. After receiving the payment card details for the new payment card, the client device 600 can validate the payment card (e.g., via the virtual card system 102 or another system) and provide the added card within the input field of the overlay 608. The client device 600 can also display a selected card from the dropdown list 610 within the input field of the overlay 608 in response to a selection of a previously entered card.

According to one or more embodiments, the client device 600 determines whether a selected payment card (e.g., a previously stored card selected from the dropdown list 610) is associated with a virtual card of the virtual card system 102. To illustrate, the client device 600 sends a reference identifier to the virtual card system 102 in response to a selection of a payment card with a corresponding reference identifier. In one or more embodiments, the virtual card system 102 determines that the selected payment card is associated with one or more virtual cards via the reference identifier from the client device 600 and according to a virtual card account mapping at the virtual card system 102.

Additionally, the virtual card system 102 can select a virtual card from the virtual card account mapping based on transaction information associated with the payment transaction. For instance, the client device 600 can also provide a merchant identifier or other transaction data to the virtual card system 102. The virtual card system 102 can select a virtual card from a plurality of virtual cards based on the merchant identifier or additional transaction data. The virtual card system 102 can return the virtual card to the client device 600. In addition, the virtual card system 102 can send virtual card verification data including an expiration date and a card verification value to the client device 600.

In response to the virtual card system 102 determining that the payment card corresponds to a virtual card, the virtual card system 102 sends the virtual card details to the client device 600 with autofilling instructions to autofill a plurality of payment credential fields of the graphical user interface 602 with the virtual card details. For example, as illustrated in FIG. 6C, the client device 600 inserts a virtual card identification number of the virtual card into an account number field 614. As shown, the virtual card identification number (ending in “0011” as illustrated) is different than the partially obfuscated payment card number (ending in “1234”) of the corresponding payment card (e.g., based on the last four digits). Furthermore, the client device 600 automatically inserts a received expiration date corresponding to the virtual card into an expiration date field 616 and a received card verification value into a CVV field 618. Thus, the client device 600 autofills virtual card details associated with the virtual card instead of requiring a user to manually input one or more payment card details (e.g., the card verification value of the payment card).

Furthermore, as illustrated in FIG. 6C, the graphical user interface 602 includes a card selection option 620 for selecting a payment card to use with the payment transaction. In particular, in response to selection of the card selection option 620, the client device 600 utilizes the information from the plurality of payment credential fields as the payment card information for processing the payment transaction. Additionally, in response to a selection of the card selection option 620, the client device 600 can display the selected payment card as the payment method in the graphical user interface with the order summary.

Additionally, the graphical user interface includes a checkout option 622 to initiate the transaction process. For example, in response to a selection of the checkout option 622, the client device 600 sends the virtual card details to a merchant system for processing the payment transaction. The merchant system can also send the received virtual card details to the virtual card system 102 to validate the virtual card details and process the payment transaction. Furthermore, in response to validating the received virtual card details, the virtual card system 102 utilizes the virtual card account mapping to swap the virtual card for the corresponding payment card and process the payment transaction via a payment network.

As illustrated in FIG. 6D, upon completion of a payment transaction process, the client device 600 displays a payment completion message 624. Specifically, the client device 600 can receive an indication of a successful payment transaction process from the virtual card system 102. In one or more embodiments, the payment completion message 624 includes a payment amount and an indicator of the payment card used to process the payment transaction. Accordingly, the client device 600 displays a summary of the payment transaction with the selected payment card instead of the virtual card.

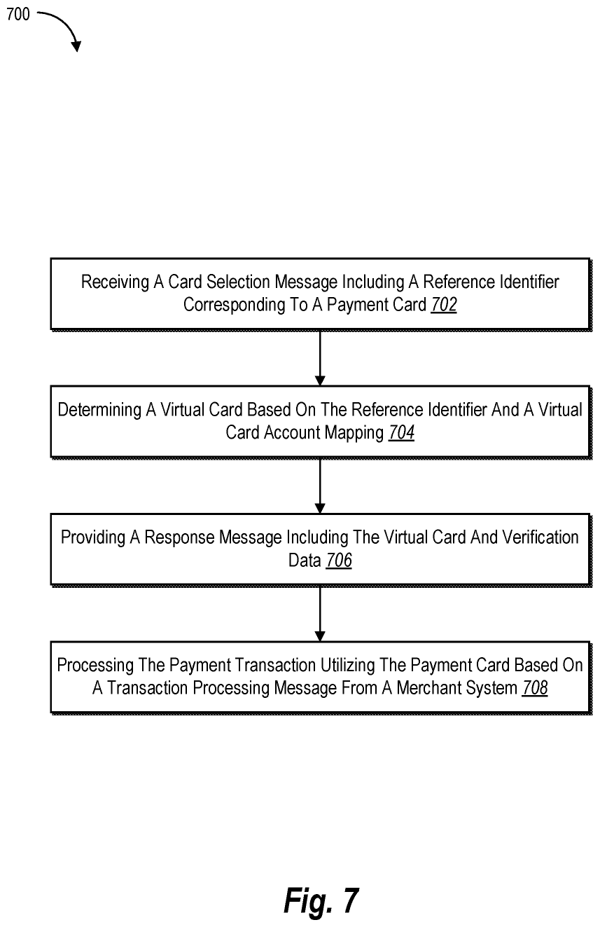

Turning now to FIG. 7, this figure shows a flowchart of a series of acts 700 of utilizing a virtual card to autofill payment card verification data in a payment transaction. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer readable storage medium can comprise instructions, that when executed by one or more processors, cause a computing device to perform the acts of FIG. 7. In still further embodiments, a system can perform the acts of FIG. 7.

As shown, the series of acts 700 includes an act 702 of receiving a card selection message including a reference identifier corresponding to a payment card. For example, act 702 involves receiving, from a client device, a card selection message comprising a reference identifier indicating a selection of a payment card account in connection with autofilling payment account information for a payment transaction.

Act 702 can involve providing an application programming interface comprising a plurality of interaction operations for access by a browser at the client device. Act 702 can involve receiving, via the browser of the client device, the card selection message based on an interaction operation of the plurality of interaction operations.

Act 702 can involve receiving the card selection message comprising transaction data corresponding to the payment transaction. Act 702 can also involve selecting the virtual card of the plurality of virtual cards based on the transaction data indicating one or more transaction scenarios.

As part of act 702, or as an additional act, the series of acts 700 includes receiving, via a browser of the client device, an autofill registration message comprising a primary account number corresponding to a payment card account. The series of acts 700 can include generating, in response to the autofill registration message, the virtual card comprising the virtual card identification number representing the primary account number. For example, the series of acts 700 can include receiving, from a client device associated with the payment card account, a request to generate the virtual card for the payment card account. The series of acts 700 can include generating the virtual card in response to the request and providing a reference number corresponding to the virtual card to the client device. Additionally, the series of acts 700 can include generating the virtual card further comprises generating the virtual card verification data comprising an expiration date and a card verification value associated with the virtual card.

The series of acts 700 can also include generating a plurality of virtual cards representing the payment card account for a plurality of different transaction scenarios involving the payment card account. For example, the series of acts 700 can include generating the virtual card for one or more transaction scenarios of the plurality of transaction scenarios. The series of acts 700 can also include generating an additional card for one or more additional transaction scenarios of the plurality of transaction scenarios.

For example, the series of acts 700 can include generating a first virtual card representing the payment card account in connection with the merchant system, and generating a second virtual card representing the payment account in connection with an additional merchant system. In one or more embodiments, the series of acts 700 includes determining a plurality of merchant systems involved in payment transactions associated with the payment card account and generating a plurality of virtual cards corresponding to the plurality of merchant systems. The series of acts 700 can also include associating the first virtual card and the second virtual card with the reference identifier in the virtual card account mapping.

In one or more embodiments, the series of acts 700 includes generating virtual card controls limiting use of the plurality of virtual cards to payment transactions involving the plurality of merchant systems. Additionally, the series of acts 700 can include generating virtual card controls that limit use of the plurality of virtual cards based on one or more additional attributes of a payment transaction including location data, time data, or a payment amount.

The series of acts 700 can also include generating the reference identifier by mapping the virtual card to the payment card account in the virtual card account mapping. The series of acts 700 can then include providing the reference identifier corresponding to the virtual card to the client device.

The series of acts 700 also includes an act 704 of determining a virtual card based on the reference identifier and a virtual card account mapping. For example, act 704 involves determining, based on the reference identifier received from the client device, a virtual card corresponding to the payment card account from a virtual card account mapping for the payment card account.

Act 704 can involve determining that a merchant identifier received in connection with the card selection message corresponds to the merchant system. For example, act 704 can involve receiving a merchant identifier corresponding to the merchant system in connection with the card selection message. Act 704 can involve selecting from the plurality of virtual cards, the virtual card based on the merchant identifier. For example, act 704 can involve selecting the first virtual card from the virtual card account mapping based on the merchant identifier corresponding to the merchant system.

Additionally, the series of acts 700 includes an act 706 of providing a response message including the virtual card and verification data. For example, act 706 involves providing, to the client device, a response message comprising a virtual card identification number and virtual card verification data corresponding to the virtual card. In one or more embodiments, the virtual card verification data comprises an expiration date and a card verification value.

Act 706 can involve providing, to the client device, the expiration date and the card verification value associated with the virtual card with the virtual card identification number. Act 706 can also involve providing autofilling instructions to a client application of the client device to cause the client device to autofill a plurality of payment credential fields comprising the virtual card identification number, the expiration date, and the card verification value. For example, the client application can include a browser.

Act 706 can involve determining, from the virtual card account mapping, one or more transaction requirements based on virtual card account controls associated with the virtual card. Act 706 can further involve providing the response message comprising in response to determining that the payment transaction meets the one or more transaction requirements.

The series of acts 700 further includes an act 708 of processing the payment transaction utilizing the payment card based on a transaction processing message from a merchant system. For example, act 708 involves processing, in response to receiving a transaction processing message from a merchant system, the payment transaction utilizing the payment card account based on the virtual card account mapping and the transaction processing message comprising the virtual card identification number and the virtual card verification data.

Act 708 can involve receiving the transaction processing message from the merchant system and transaction data corresponding to the payment transaction. Act 708 can also involve validating the virtual card based on the virtual card identification number, the virtual card verification data, and the transaction data. Act 708 can involve providing, to a payment network comprising a payment card provider system associated with the payment card account, payment credentials for the payment card account and the transaction data.

Act 708 can involve validating, utilizing the virtual card account mapping, the virtual card based on the virtual card identification number and the virtual card verification data from the transaction processing message. Act 708 can also involve providing payment credentials associated with the payment card account to a payment network in response to validating the virtual card.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates a block diagram of exemplary computing device 800 that may be configured to perform one or more of the processes described above. One will appreciate that one or more computing devices such as the computing device 800 may implement the system(s) of FIG. 1. As shown by FIG. 8, the computing device 800 can comprise a processor 802, a memory 804, a storage device 806, an I/O interface 808, and a communication interface 810, which may be communicatively coupled by way of a communication infrastructure 812. In certain embodiments, the computing device 800 can include fewer or more components than those shown in FIG. 8. Components of the computing device 800 shown in FIG. 8 will now be described in additional detail.

In one or more embodiments, the processor 802 includes hardware for executing instructions, such as those making up a computer program. As an example, and not by way of limitation, to execute instructions for dynamically modifying workflows, the processor 802 may retrieve (or fetch) the instructions from an internal register, an internal cache, the memory 804, or the storage device 806 and decode and execute them. The memory 804 may be a volatile or non-volatile memory used for storing data, metadata, and programs for execution by the processor(s). The storage device 806 includes storage, such as a hard disk, flash disk drive, or other digital storage device, for storing data or instructions for performing the methods described herein.

The I/O interface 808 allows a user to provide input to, receive output from, and otherwise transfer data to and receive data from computing device 800. The I/O interface 808 may include a mouse, a keypad or a keyboard, a touch screen, a camera, an optical scanner, network interface, modem, other known I/O devices or a combination of such I/O interfaces. The I/O interface 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 808 is configured to provide graphical data to a display for presentation to a user. The graphical data may be representative of one or more graphical user interfaces and/or any other graphical content as may serve a particular implementation.

The communication interface 810 can include hardware, software, or both. In any event, the communication interface 810 can provide one or more interfaces for communication (such as, for example, packet-based communication) between the computing device 800 and one or more other computing devices or networks. As an example, and not by way of limitation, the communication interface 810 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 810 may facilitate communications with various types of wired or wireless networks. The communication interface 810 may also facilitate communications using various communication protocols. The communication infrastructure 812 may also include hardware, software, or both that couples components of the computing device 800 to each other. For example, the communication interface 810 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

1. A computer-implemented method comprising:
receiving, by one or more servers from a client device, a card selection message comprising a reference identifier indicating a selection of a payment card account in connection with autofilling payment account information for a payment transaction;
determining, by the one or more servers and based on the reference identifier received from the client device, a virtual card corresponding to the payment card account from a virtual card account mapping for the payment card account;
providing, by the one or more servers to the client device, a response message comprising a virtual card identification number and virtual card verification data generated for the virtual card for autofilling the payment account information for the payment transaction, the virtual card verification data of the virtual card being different than card verification data associated with the payment card account; and
processing, by the one or more servers in response to receiving a transaction processing message from a merchant system including the virtual card identification number and the virtual card verification data, the payment transaction utilizing the payment card account based on the virtual card account mapping.

2. The computer-implemented method as recited in claim 1, further comprising:
receiving, via the client device, an autofill registration message comprising a primary account number corresponding to a payment card account;
generating, in response to the autofill registration message, the virtual card comprising the virtual card identification number representing the primary account number;
generating the reference identifier by mapping the virtual card to the payment card account in the virtual card account mapping; and
providing the reference identifier corresponding to the virtual card to the client device.

3. The computer-implemented method as recited in claim 2, wherein
generating the virtual card further comprises generating the virtual card verification data comprising an expiration date and a card verification value associated with the virtual card.

4. The computer-implemented method as recited in claim 3, wherein providing the response message comprises:
providing, to the client device, the expiration date and the card verification value associated with the virtual card with the virtual card identification number; and
causing, by providing autofilling instructions to the client device in response to the selection of the payment card account, the client device to autofill a plurality of payment credential fields comprising the virtual card identification number, the expiration date, and the card verification value.

5. The computer-implemented method as recited in claim 2, wherein generating the virtual card further comprises generating a plurality of virtual cards representing the payment card account for a plurality of different transaction scenarios involving the payment card account.

6. The computer-implemented method as recited in claim 5, further comprising:
generating a first virtual card representing the payment card account in connection with the merchant system;
generating a second virtual card representing the payment card account in connection with an additional merchant system; and
associating the first virtual card and the second virtual card with the reference identifier in the virtual card account mapping.

7. The computer-implemented method as recited in claim 6, wherein determining the virtual card comprises:
determining that a merchant identifier received in connection with the card selection message corresponds to the merchant system; and
selecting the first virtual card from the virtual card account mapping based on the merchant identifier corresponding to the merchant system.

8. The computer-implemented method as recited in claim 1, wherein providing the response message comprises:
determining, from the virtual card account mapping, one or more transaction requirements based on virtual card account controls associated with the virtual card; and
providing the response message comprising in response to determining that the payment transaction meets the one or more transaction requirements.

9. The computer-implemented method as recited in claim 1, wherein processing the payment transaction comprises:
validating, utilizing the virtual card account mapping, the virtual card based on the virtual card identification number and the virtual card verification data from the transaction processing message; and
providing payment credentials associated with the payment card account to a payment network in response to validating the virtual card.

10. A system comprising:
at least one processor; and
a non-transitory computer readable storage medium comprising instructions that, when executed by the at least one processor, cause the system to:
receive, from a client device, a card selection message comprising a reference identifier indicating a selection of a payment card account in connection with autofilling payment account information for a payment transaction;
determine, based on the reference identifier received from the client device, a virtual card corresponding to the payment card account from a virtual card account mapping for the payment card account;
provide, to the client device, a response message comprising a virtual card identification number and virtual card verification data generated for the virtual card for autofilling the payment account information for the payment transaction, the virtual card verification data of the virtual card being different than card verification data associated with the payment card account; and
process, in response to receiving a transaction processing message comprising the virtual card identification number and the virtual card verification data, the payment transaction utilizing the payment card account based on mapping the virtual card identification number and the virtual card verification data to the payment card account utilizing the virtual card account mapping.

11. The system as recited in claim 10, further comprising instructions that, when executed by the at least one processor, cause the system to provide the response message by:
providing, to the client device, the virtual card verification data comprising an expiration date and a card verification value with the virtual card identification number; and
providing autofilling instructions to a client application of the client device to cause the client device to autofill a plurality of payment credential fields with the virtual card identification number, the expiration date, and the card verification value.

12. The system as recited in claim 10, further comprising instructions that, when executed by the at least one processor, cause the system to:
receive, from a client device associated with the payment card account, a request to generate the virtual card for the payment card account;
generate the virtual card in response to the request; and
provide a reference number corresponding to the virtual card to the client device.

13. The system as recited in claim 10, further comprising instructions that, when executed by the at least one processor, cause the system to:
determine a plurality of merchant systems involved in payment transactions associated with the payment card account;
generating a plurality of virtual cards corresponding to the plurality of merchant systems; and
generating virtual card controls limiting use of the plurality of virtual cards to payment transactions involving the plurality of merchant systems.

14. The system as recited in claim 13, further comprising instructions that, when executed by the at least one processor, cause the system to:
receive a merchant identifier corresponding to a merchant system of the plurality of merchant systems in connection with the card selection message; and
select, from the plurality of virtual cards, the virtual card based on the merchant identifier.

15. The system as recited in claim 10, further comprising instructions that, when executed by the at least one processor, cause the system to receive the card selection message by:
providing an application programming interface comprising a plurality of interaction operations for access by a browser at the client device; and
receiving, via the browser of the client device, the card selection message based on an interaction operation of the plurality of interaction operations.

16. The system as recited in claim 10, further comprising instructions that, when executed by the at least one processor, cause the system to process the payment transaction by:
receiving the transaction processing message from a merchant system and transaction data corresponding to the payment transaction;
validating the virtual card based on the virtual card identification number, the virtual card verification data, and the transaction data; and
providing, to a payment network comprising a payment card provider system associated with the payment card account, payment credentials for the payment card account and the transaction data.

17. A non-transitory computer readable storage medium comprising instructions that, when executed by at least one processor, cause the at least one processor to:
receive, from a client device, a card selection message comprising a reference identifier indicating a selection of a payment card account in connection with autofilling payment account information for a payment transaction;
determine, based on the reference identifier received from the client device, a virtual card corresponding to the payment card account from a virtual card account mapping for the payment card account;
provide, to the client device, a response message comprising a virtual card identification number and virtual card verification data generated for the virtual card for autofilling the payment account information for the payment transaction, the virtual card verification data of the virtual card being different than card verification data associated with the payment card account;
receive a transaction processing message from a merchant system comprising the virtual card identification number and the virtual card verification data;
mapping the virtual card identification number and the virtual card verification data to the payment card account based on the virtual card account mapping; and
process the payment transaction utilizing the payment card account.

18. The non-transitory computer readable storage medium as recited in claim 17, further comprising instructions that, when executed by the at least one processor, cause the at least one processor to:
generate, in response to a request, the virtual card for the payment card account including the virtual card identification number, an expiration date, and a card verification value;
provide, to the client device in response to the card selection message, the virtual card identification number and the virtual card verification data comprising the expiration date and the card verification value; and
provide autofilling instructions to a client application of the client device to cause the client device to autofill a plurality of payment credential fields with the virtual card identification number, the expiration date, and the card verification value.

19. The non-transitory computer readable storage medium as recited in claim 17, further comprising instructions that, when executed by the at least one processor, cause the at least one processor to:
determine a plurality of transaction scenarios associated with the payment card account;
generate the virtual card for one or more transaction scenarios of the plurality of transaction scenarios; and
generate an additional card for one or more additional transaction scenarios of the plurality of transaction scenarios.

20. The non-transitory computer readable storage medium as recited in claim 19, further comprising instructions that, when executed by the at least one processor, cause the at least one processor to:
receive the card selection message comprising transaction data corresponding to the payment transaction; and
select the virtual card of a plurality of virtual cards based on the transaction data indicating the one or more transaction scenarios.
